(19) United States
(12) Patent Application Publication
(10) Pub. No.: US 2008/0212987 A1
(43) Pub. Date: Sep. 4, 2008

(54) IMAGE FORMING APPARATUS AND METHOD OF CONTROLLING THE SAME

(76) Inventor: Dong Sik KIM, Suwon-si (KR)

Correspondence Address: STANZIONE & KIM, LLP, 919 18TH STREET, N.W., SUITE 440, WASHINGTON, DC, 20006, US

(21) Appl. No.: 12/025,302

(22) Filed: Feb. 4, 2008

(30) Foreign Application Priority Data
Feb. 6, 2007 (KR) 2007-12410
Jan. 28, 2008 (KR) 2008-8485

(51) Int. Cl. G03G 15/00

(52) U.S. Cl. 399/44

(57) ABSTRACT

An image forming apparatus and a method of controlling the same. The contamination of a transfer roller is determined based on detection results of a peripheral environment using the measured resistance and the internal temperature of the transfer roller, the contaminated transfer roller is cleaned, and then an image corresponding to printing data stored when the transfer roller is contaminated is printed on a new fed sheet.

### CROSS-REFERENCE TO RELATED APPLICATIONS

This application claims priority under 35 U.S.C. §119(a) from Korean Patent Applications No. 2007-12410, filed on Feb. 6, 2007, and No. 2008-8485, filed on Jan. 28, 2008, in the Korean Intellectual Property Office, the disclosures of which are incorporated

### BACKGROUND OF THE INVENTION

1. Field of the Invention

The present general inventive concept relates to an image forming apparatus and a method of controlling the same, and more particularly, to an image forming apparatus and a method of controlling the same, capable of measuring a resistance and an internal temperature of a transfer roller to determine contamination of the transfer roller.

2. Description of the Related Art

Image forming apparatuses (e.g., a laser printer, a multifunctional peripheral (MFP), etc.) employ an electro-photography method in order to perform a printing operation, and include high voltage power supplies (HVPSs) applying high voltage to a charge roller, a photoconductive drum, a developing roller, etc.

The transfer roller is made of an insulating material having a high resistance value, and the resistance value of the transfer roller varies depending on the temperature and humidity.

In order to transfer a toner image applied to the photoconductive drum onto paper without residues, the transfer voltage of the transfer roller must be determined by taking the resistance value of the transfer roller, which varies depending on the temperature and humidity, into consideration. In other words, the transfer voltage must be determined based on the resistance value of the transfer roller varying depending on environmental conditions, so as to ensure superior printing quality. Such a high voltage determining scheme based on environmental conditions is illustrated in FIG. 1.

As illustrated in FIG. 1, the voltage applied to the transfer roller is measured (step 1), the measured voltage is converted into binary data (step 2), and a pre-established table is searched based on the binary data such that the resistance value of the transfer roller corresponding to the binary data can be obtained (step 3). In this case, the pre-established table comprises typically a look-up table (LUT) 7 as illustrated in FIG. 2.

The look-up table 7 comprises a code number representing a PI value, the resistance of the transfer roller (T/R), and a PWM duty used to determine the voltage applied to each roller corresponding to the resistance of the transfer roller (T/R). The PWM duty comprises transfer voltage (Thv) applied to the transfer roller, charging voltage applied to the charging roller, and developing bias voltage (DevBias) applied to the developing roller. The table 7 shows resistance characteristics measured under the high temperature and high humidity at an upper portion thereof and resistance characteristics measured under the low temperature and low humidity at lower portion thereof.

After obtaining the resistance of the transfer roller, the transfer voltage, the developing bias voltage, and the charging voltage corresponding to the resistance of the transfer roller are determined from the look-up table (step 4).

Then, it is determined whether a time point to apply high voltage, which is used to start a printing operation, to each roller has come (step 5). If the determination result shows that the time point has come, the determined voltage is applied to the charging roller, the developing roller, and the transfer roller through the HVPS, and thus the printing operation is achieved (step 6).

However, since toner, which is not transferred onto the paper, may remain between the transfer roller and the photoconductive drum, or on the surface of the transfer roller, the resistance of the transfer roller may be changed. Accordingly, the environmental conditions of the image forming apparatus may be erroneously detected. For this reason, not only is the fusing temperature of toner erroneously set, but also the high voltage for the transfer roller, the voltage used to supply the toner, and the voltage used to prevent the toner from being supplied to the photoconductive drum may be erroneously applied due to the erroneous detection of the environmental conditions, so the image quality may be degraded.

### SUMMARY OF THE INVENTION

The present general inventive concept provides an image forming apparatus and a method of controlling the same, capable of determining contamination of a transfer roller by using a peripheral environment detection result based on a measured resistance and internal temperature of the transfer roller.

Additional aspects and/or advantages of the present general inventive concept will be set forth in part in the description which follows and, in part, will be apparent from the description, or may be learned by practice of the general inventive concept.

The foregoing and/or other aspects and utilities of the present general inventive concept are achieved by providing an image forming apparatus including a resistance measuring unit to measure a resistance of a transfer roller, a temperature measuring unit to measure an internal temperature, a first detecting unit to detect a peripheral environment by using the resistance of the transfer roller, a second detecting unit to detect a peripheral environment by using the internal temperature, and a controller to determine contamination of the transfer roller by using the detection results of the first and second detecting units.

The controller may determine the contamination of the transfer roller according to the detection result of the second detecting unit after the first detecting unit detects a peripheral environment.

The image forming apparatus may further include a counter to accumulate a frequency of detection of the peripheral environment.

The accumulated frequency of the detection of the peripheral environment corresponds to the number of printed sheets.

The accumulated frequency of the detection of the peripheral environment or the number of the printed sheets is reset if the image forming apparatus is in a sleep state.

The controller may include a short-time contamination determining unit to determine if a contamination time of the transfer roller is first time, and a long-time contamination determining unit to determine if the contamination time of the transfer roller is second time greater than the first time.

The short-time contamination determining unit may determine whether the transfer roller is contaminated if a difference between a previous PI value and a present PI value is not in a normal range, and the long-time contamination determining unit may determine whether the transfer roller is contaminated if PI value inclination is not a normal range.

The image forming apparatus may further include a display unit to display the contamination of the transfer roller if the transfer roller is contaminated as the detection results of the first and second detecting units.

The transfer roller may be cleaned if the transfer roller is contaminated as the detection results of the first and second detecting units.

The transfer roller may be automatically cleaned, or manually cleaned according to a user's command.

The user's command may be input through a manipulation panel of the image forming apparatus.

The image forming apparatus may further include a storage unit to store printing data if the transfer roller is contaminated, and the controller may print an image corresponding to the printing data stored in the storage unit on a new fed sheet after cleaning the transfer roller.

The foregoing and/or other aspects and utilities of the present general inventive concept may also be achieved by providing a method of controlling an image forming apparatus, the method including measuring a resistance of a transfer roller, measuring an internal temperature, and determining contamination of the transfer roller by using detection results of a peripheral environment according to the measured resistance and the measured internal temperature.

The determining of the contamination of the transfer roller may further include determining the contamination of the transfer roller according to the detection result of the peripheral environment based on the internal temperature after the peripheral environment is detected by using the resistance.

The determining of the contamination of the transfer roller may further include determining a contamination time, and applying a contamination determining criterion varied depending on the contamination time.

The determining of the contamination time may further include accumulating a frequency of detection of a peripheral environment, and determining the contamination time as a short time or a long time according to the frequency of the detection of the peripheral environment.

The frequency of the detection of the peripheral environment may correspond to the number of printed sheets.

The frequency of the detection of the peripheral environment or the number of the printed sheets may be reset if the image forming apparatus is a sleep state.

Whether a difference between a previous PI value and a present PI value is a normal range is determined if the contamination time is short time, and whether PI value inclination is in a normal range is determined if the contamination time is long time.

The method of controlling the image forming apparatus may further include displaying the contamination of the transfer roller if the transfer roller is contaminated.

The method of controlling the image forming apparatus may further include cleaning the transfer roller if the transfer roller is contaminated.

The transfer roller may be automatically cleaned or manually cleaned according to a user's command.

The method of controlling the image forming apparatus may include storing printing data if the transfer roller is contaminated, and printing an image corresponding to the printing data on a new fed sheet after cleaning the transfer roller.

The foregoing and/or other aspects and utilities of the present general inventive concept may also be achieved by providing a computer-readable medium to contain computer-readable codes as a program to execute a method of an image forming apparatus, the method including measuring resistance of a transfer roller, measuring an internal temperature, and determining contamination of the transfer roller by using detection results of a peripheral environment according to the measured resistance and the measured internal temperature.

The foregoing and/or other aspects and utilities of the present general inventive concept may also be achieved by providing an image forming apparatus including a first measuring unit to measure a resistance of a transfer roller, a second measuring unit to measure an internal temperature, and a controller to determine contamination of the transfer roller according to a peripheral environment including the measured resistance and the measured internal temperature.

### BRIEF DESCRIPTION OF THE DRAWINGS

The above and other objects, features and advantages of the present general inventive concept will be more apparent from the following detailed description taken in conjunction with the accompanying drawings, in which:

FIG. 1 is a flowchart illustrating a conventional method of applying a high voltage according to detection of a peripheral environment;

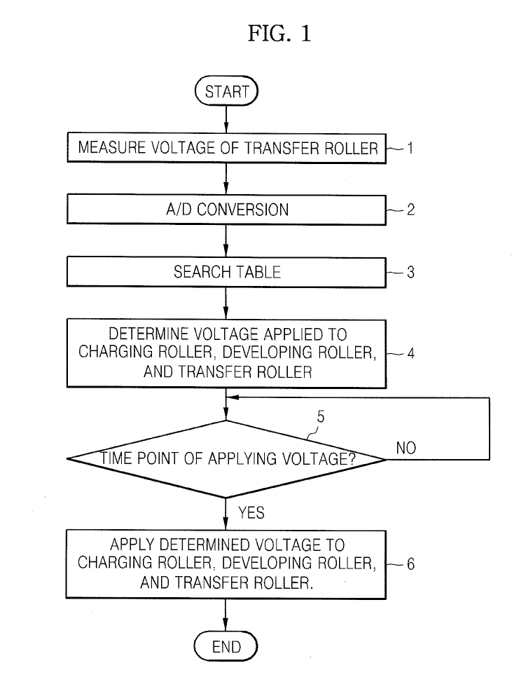

FIG. 2 is a table illustrating a PWM duty of a high voltage applied corresponding to a resistance of a transfer roller;

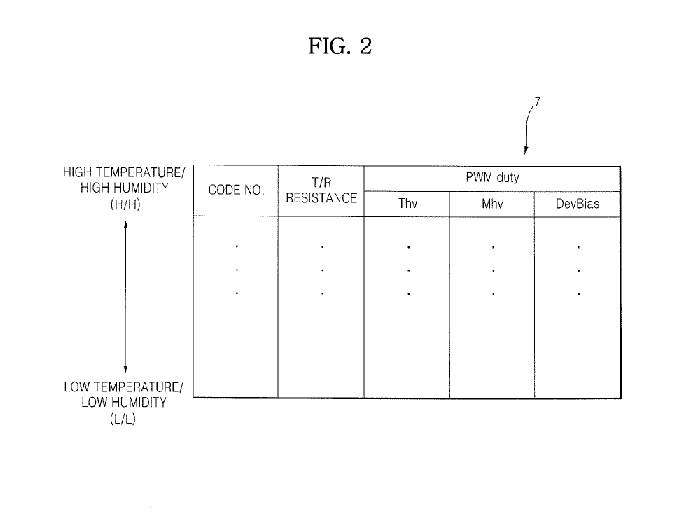

FIG. 3 is a block diagram illustrating an image forming apparatus according to an embodiment of the present general inventive concept;

FIG. 4 is a graph illustrating a variation of PI values when a transfer roller is contaminated during a short-time printing operation;

FIG. 5 is a graph illustrating a resistance of the transfer roller measured in FIG. 4;

FIG. 6 is a graph illustrating a variation of PI values when a transfer roller is contaminated during a long-time printing operation;

FIG. 7 is a graph illustrating a resistance of the transfer roller measured in FIG. 6;

FIG. 8 is a graph illustrating a variation of PI values when a transfer roller is contaminated while a long-time printing operation is performed by lowering a voltage applied to the transfer roller;

FIG. 9 is a graph illustrating a resistance of the transfer roller measured in FIG. 8;

FIG. 10 is a flowchart illustrating a method of setting up a transfer roller contamination check counter to determine a peripheral environment according to a detection state of an image forming apparatus according to an embodiment of the present general inventive concept;

FIG. 11 is a flowchart illustrating a method of determining contamination of a transfer roller during a short-time printing operation by employing an advanced peripheral environment detecting scheme according to an embodiment of the present general inventive concept;

FIG. 12 is a flowchart illustrating a method of determining contamination of a transfer roller during a long-time printing operation by employing an advanced peripheral environment detecting scheme according to an embodiment of the present general inventive concept; and

FIG. 13 is a flowchart illustrating a method of performing a printing operation after cleaning of a transfer roller when it is determined that the transfer roller is contaminated by employing an advanced peripheral environment detecting scheme according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below to explain the present general inventive concept by referring to the figures.

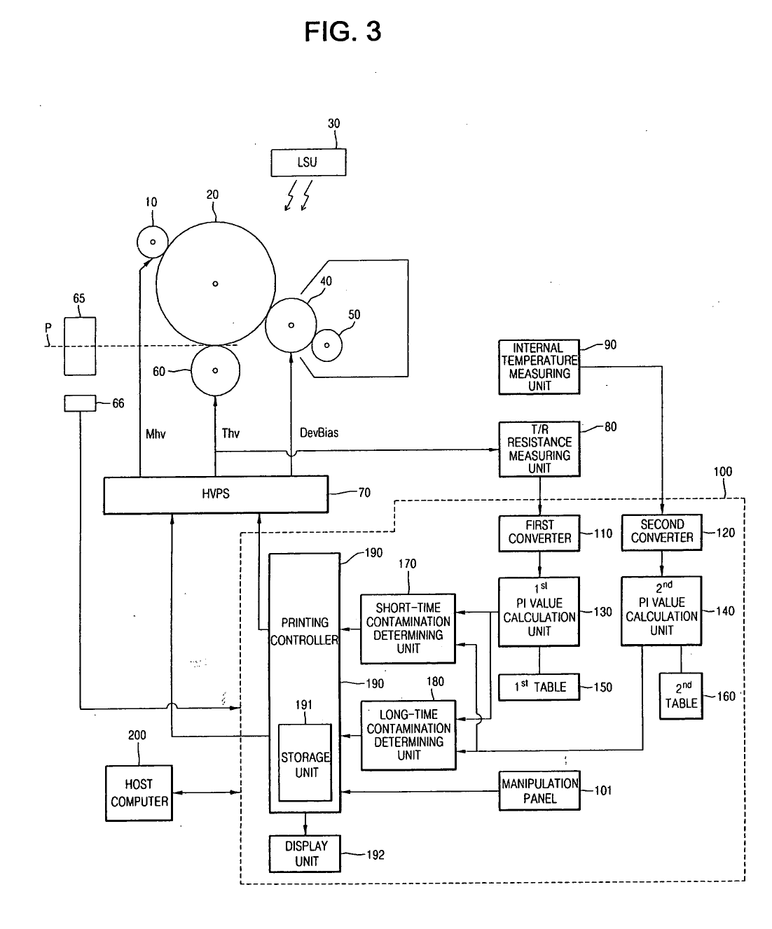

As illustrated in FIG. 3, an image forming apparatus includes a charging roller 10, a photoconductive drum 20, an exposing unit 30 having a laser scan unit (LSU), a developing roller 40, a toner supplying roller 50, and a transfer roller 60 and uses the above-described and other elements to employ an electro-photography method.

In addition, the image forming apparatus further includes a high voltage power supply (HVPS) 70 to apply a driving voltage to elements to perform a printing operation. The high voltage power supply 70 applies a charging voltage (Mhv) to the charging roller 10, a transfer voltage (Thv) to the transfer roller 60, and a developing bias voltage DevBias to the developing roller 40 according to the control of a printing controller 190 which is described later.

The image forming apparatus further includes a transfer roller resistance measuring unit 80 to receive a voltage applied to the transfer roller 60 to correspond to the transfer voltage Mhv, to measure a resistance of the transfer roller 60, an internal temperature measuring unit 90 to receive a voltage of an internal temperature sensor to measure an internal temperature of the image forming apparatus, and a system controller 100 to determine a contamination state of the transfer roller 60 depending on the measurement results of the transfer roller resistance measuring unit 80 and the internal temperature measuring unit 90, and to clean the transfer roller 60 if it is determined that the transfer roller 60 is contaminated.

Here, the internal temperature indicates a temperature of an inside of a body of the image forming apparatus. The body of the image forming apparatus may include therein at least a printing unit including the photoconductive drum 20, the developing roller 40, and the transfer roller 60. It is possible that other components of FIG. 3 can be disposed in the body of the image forming apparatus.

The system controller 100 controls the overall operation of the image forming apparatus to receive printing data from a host computer 200 and to perform a printing operation of forming or printing an image on a print medium according to the printing data. It is possible that the controller 100 of the image forming apparatus may receive scan data as the printing data from a scanning unit to scan a document to generate the scan data as the printing data. The system controller 100 may controls the above-describe elements to perform the printing operation according to the printing data (or scan data).

The system controller 100 includes a first converter 110 to output binary data corresponding to the transfer voltage received in the transfer roller resistance measuring unit 80, a first PI value calculation unit 130, which searches a first table 150 for the resistance of the transfer roller according to the binary data output from the first converter 110 and a first PI value corresponding to the resistance of the transfer roller so as to provide the search result to a short-time contamination determining unit 170 and a long-time contamination determining unit 180, a second converter 120 to output binary data corresponding to the voltage of the internal temperature sensor received in the internal temperature measuring unit 90, a second PI value calculation unit 140, which searches a second table 160 for an internal temperature resistance according to the binary data obtained in the second converter 110, and a second PI value corresponding to the internal temperature resistance, so as to provide the search result to the short-time contamination determining unit 170 and the long-time contamination determining unit 180.

The short-time contamination determining unit 170 receives the first and second PI values so as to determine whether short-time transfer contamination occurs and to output the determination result, and the long-time contamination determining unit 180 receives the first and second PI values so as to determine whether long-time transfer contamination occurs and to output the determination result.

The system controller 100 further includes a printing controller 190 to receive determination results of the short-time contamination determining unit 170 and the long-time contamination determining unit 180, to control the operation of applying a voltage to each unit by controlling the high voltage supply 70, and to control the operation of cleaning the contaminated transfer roller 60, and a display unit 192.

The display unit 192 displays a message or signal to correspond to the contamination of the transfer roller 60 according to the control of the printing controller 190.

The image forming apparatus may further include a fusing unit 65 to fuse an image formed on a print medium P, and a sensor to detect a temperature of the fusing unit 65 to be transmitted to the system controller 100. The detected temperature of the fusing fusing unit 65 can be used to determine a peripheral environment of the image forming apparatus in a printing operation. The image forming apparatus may further include a manipulation panel 101 to input a user command to control the system controller and/or the printing controller to perform the operation thereof including a printing operation. Accordingly, components of the image forming apparatus can be controlled to form an image.

Even if one or more printing operations are performed for a short period time, the transfer roller 60 may be contaminated. For example, when a user extracts one or more sheets of paper in a direction opposed to a forward direction of the paper in a state in which the paper enters between the transfer roller 60 and the photoconductive drum 20 due to a paper jam, non-transferred toner from the photoconductive drum 20 to the paper may contaminate the transfer roller 60.

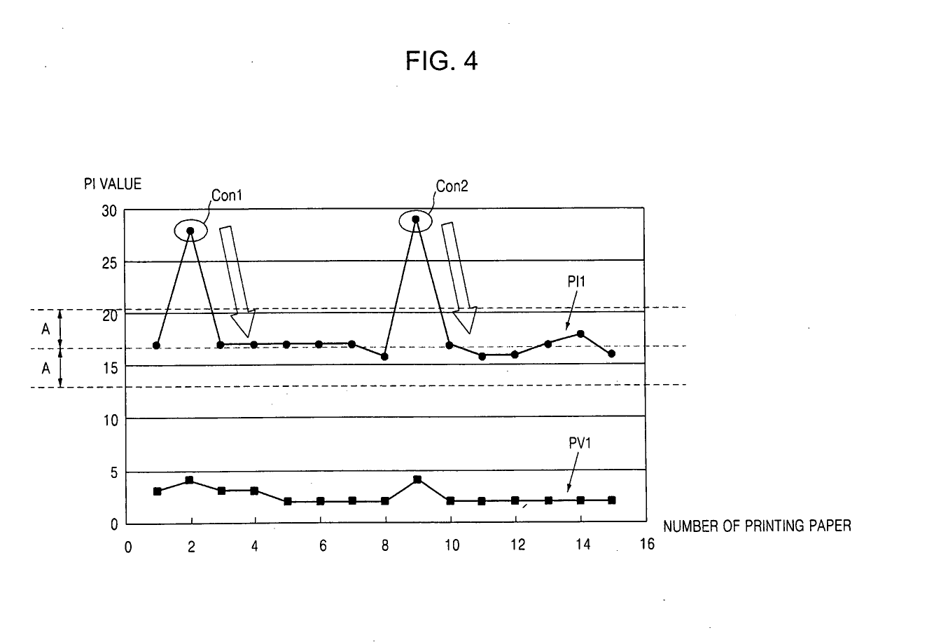

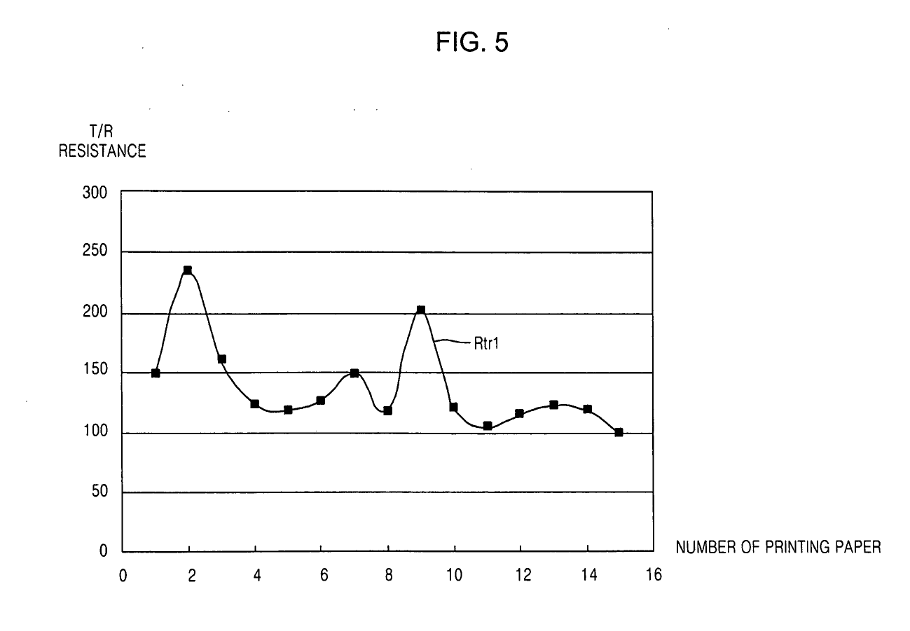

As illustrated in FIG. 4, when a first sheet of paper and an eighth sheet of paper are printed and then discharged in a printing operation of printing sixteen (16) sheets of paper, the transfer roller 60 can be contaminated during printing and/or discharging the sheets, a first PI value signal PI1 shows the first PI value, such as values of Con1 and Con2 in the second and ninth paper printing, higher than other first PI values. In addition, the first PI value signal PI1 shows that the contamination of the transfer roller 60 is rapidly reduced after the second and ninth paper printing. At this time, if the internal temperature is measured, a variation of the internal temperature is not greater than a reference, that is, the variation of the second PI value is not greater than a reference throughout the printing operation. That is, if the variation of the PI value is greater than a reference, and the variation of the internal temperature is not greater than the reference according to the execution of the printing operation, the state of the transfer roller 60 may be determined as a contamination state. As illustrated in FIG. 5, a first roller resistance signal Rtr1, which represents the resistance of the transfer roller 60, shows that the resistance of the transfer roller 60 is largely changed in the second and ninth paper printing after the first and eighth paper printing. In this case, a signal Pv1 represents reference values that are used to determine a voltage applied to the developing roller 40 and the transfer roller 60 corresponding to the PI values.

The signal Pv1 may be determined according to the first and/or second PI values, and the system controller 100 controls the HVPS 70 to generate voltages applied to the developing roller 40 and the transfer roller 60 according to the signal Pv1 when the printing operation is performed as described above.

Meanwhile, if a printing operation is performed for a long period of time, an internal air temperature is saturated so that detection of a peripheral environment is affected by the saturated air temperature.

A determination of whether the internal air temperature is saturated in the image forming apparatus can be determined according to the internal temperature of the internal temperature measuring unit 90 and/or the T/R resistance of the T/R resistance measuring unit 80.

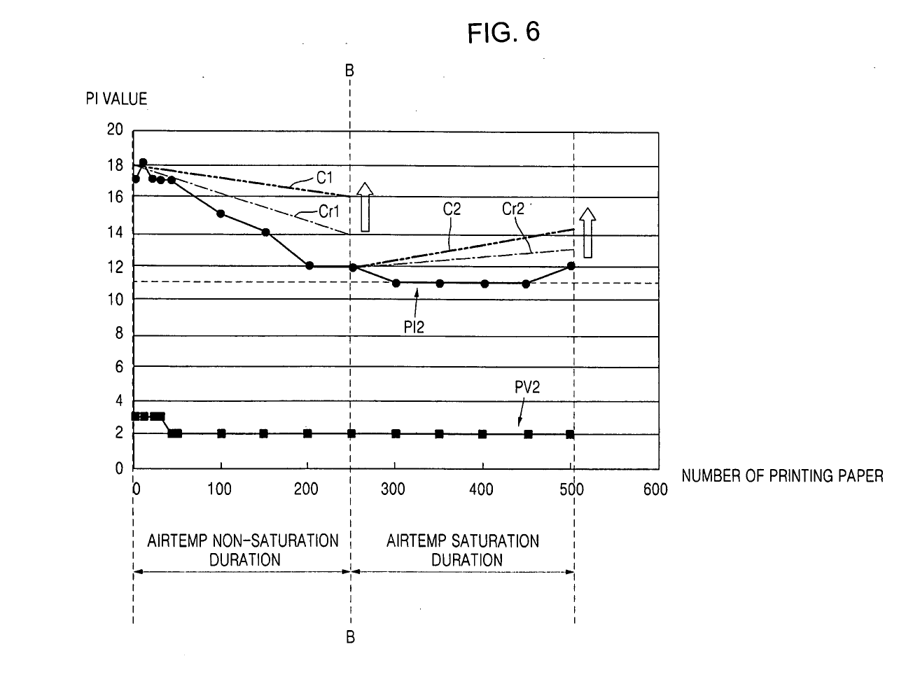

As illustrated in FIG. 6, when another printing operation of printing five hundred (500) sheets of paper is repeatedly performed with a short time interval, the transfer roller may be not contaminated. The first PI value may be lower when the internal air temperature is saturated, than when the internal air temperature is not saturated. A second PI value signal PI2 represents a variation of the first PI value to be greater than a first reference inclination Cr1 for the non-saturation duration of the internal air temperature from an initial point to a reference point B. When comparing FIG. 6 with FIG. 4, the PI values are shown closer to a high temperature and high humidity as indicated by arrows.

Here, C1 is a first inclination of the second PI value signal PI2 to correspond to the variation of the first PI value during the air temperature non-saturation duration, and C2 is a second inclination of the second PI value signal PI2 to correspond to the variation of the first PI value during the air temperature saturation duration. The first and second inclination C1 and C2 may be increased or decreased.

Accordingly, if an inclination value (angle or ratio) of the first inclination C1 to correspond to the variation of the PI values is smaller than an inclination value (angle or ratio) of the reference inclination Cr1 in an inclination direction during the air temperature non-saturation duration, the transfer roller 60 may be contaminated.

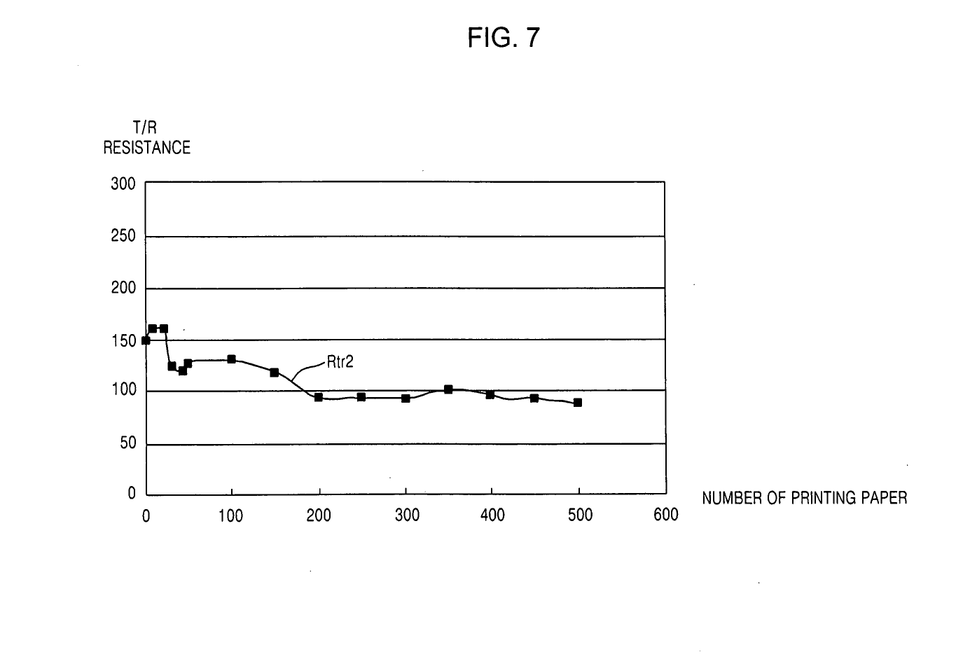

In addition, an inclination value (angle or ratio) of the second inclination C2 to correspond to the PI values are lower than an inclination value (angle or ratio) of a second reference inclination Cr2 for saturation duration of the internal air temperature, and the contamination state of the transfer roller 60 may be determined by comparing the second reference inclination Cr2 with the second inclination C2 of the second PI value signal PI2. A second transfer roller resistance signal Rtr2 is illustrated in FIG. 7 according to the saturation state of the internal air temperature. A signal Pv2 represents reference values used to determine a voltage applied to the developing roller 40 and the transfer roller 60 corresponding to the PI value.

The signal Pv2 may be determined according to the first and/or second PI values, and the system controller 100 controls the HVPS 70 to generate voltages applied to the developing roller 40 and the transfer roller 60 according to the signal Pv2 when it is determined whether the printing operation is performed in the short period of time as described above.

Meanwhile, if the printing operation is performed for a long period of time, impurities (e.g., fine dust) are gradually collected on the transfer roller 60, so that the transfer roller 60 may be contaminated. In this case, the internal air temperature is saturated so that the resistance of the transfer roller 60 is reduced, and the decrease of the resistance of the transfer roller 60 is reduced by a contamination degree caused due to the impurities collected on the transfer roller 60.

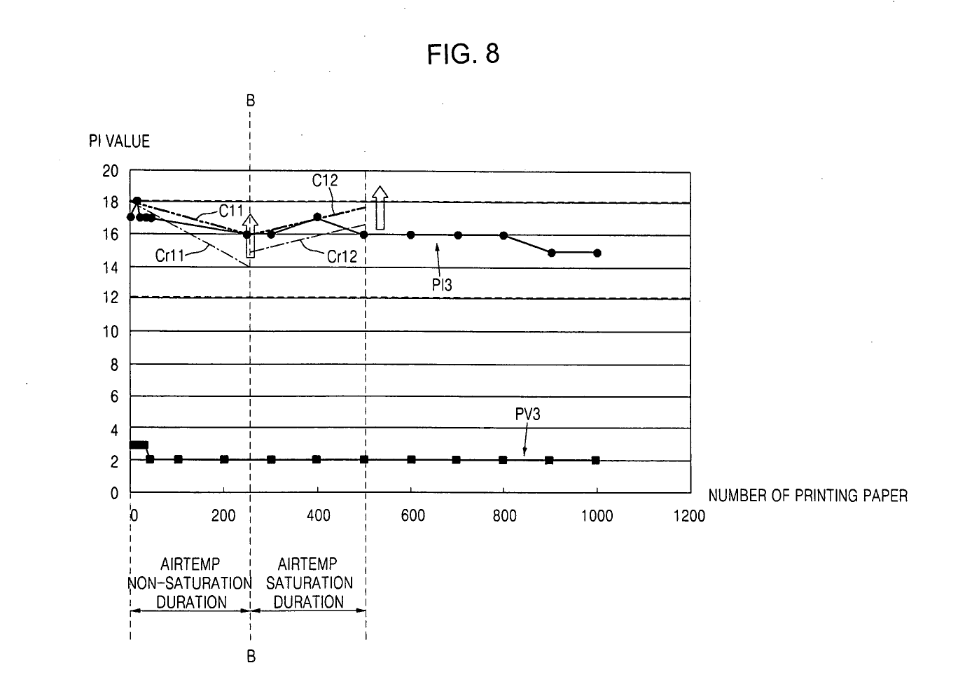

As illustrated in FIG. 8, a printing operation of printing a thousand sheets of paper is repeatedly performed with a short time interval under the same conditions as those illustrated in FIG. 6. In this case, the voltage applied to the transfer roller 60 is relatively low as compared with the voltage of the transfer roller 60 illustrated in FIG. 6. This is necessary to reduce the decrease of the resistance of the transfer roller 60 in a state in which impurities are gradually collected on the transfer roller 60. Similarly to the graph illustrated in FIG. 6, the saturation state of the internal air temperature is determined based on the reference point B.

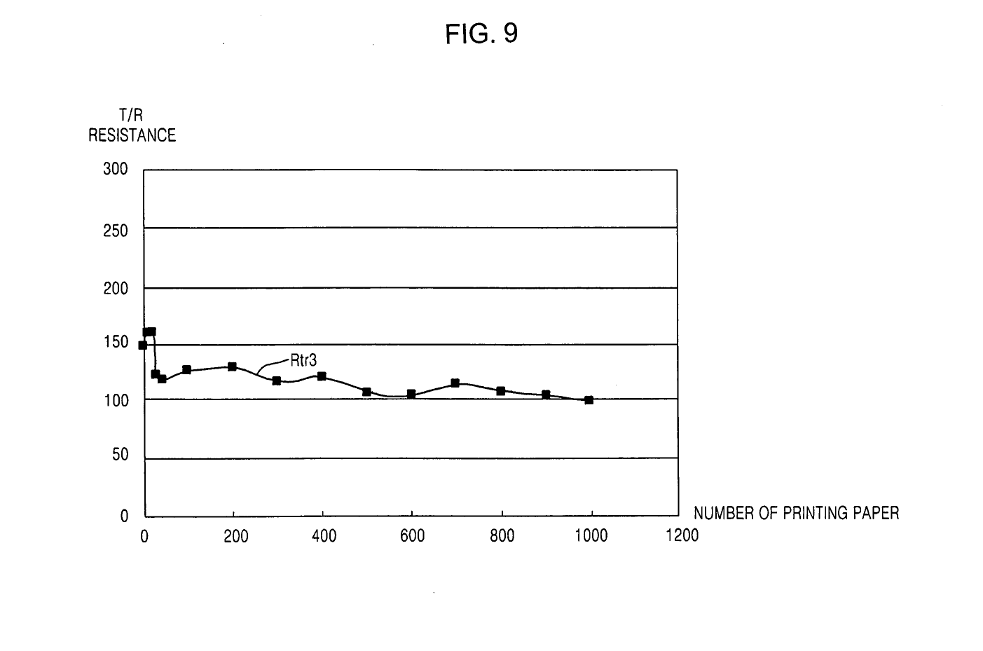

As illustrated in FIG. 8, since the transfer resistance of the transfer roller 60 is relatively less reduced, it is shown from a third PI value signal PI3 of the first PI value that an inclination representing a variation of the PI value with respect to an axis of the number of printing paper is smaller than reference inclinations Cr11 and Cr12 and greater than a reference inclination C11. When comparing the graph of FIG. 8 with the graph of FIG. 4, the PI values are shown closer to the high temperature and high humidity as indicated by arrows. Based on the comparison, the contamination state of the transfer roller 60 may be determined. A third transfer roller resistance signal Rtr3 is illustrated in FIG. 9 depending on the contamination caused by impurities gradually collected on the transfer roller when the transfer roller is used for a long time. A signal Pv3 represents reference values used to determine a voltage applied to the developing roller and the transfer roller corresponding to the PI value.

The signal Pv3 may be determined according to the first and/or second PI values, and the system controller 100 controls the HVPS 70 to generate voltages applied to the developing roller 40 and the transfer roller 60 according to the signal Pv3 when it is determined whether the printing operation is performed as described above

Hereinafter, a method of controlling an image forming apparatus will be described with respect to accompanying drawings.

First, details will be described regarding an operational procedure to set up a transfer roller contamination check counter in order to determine a process for a short-time contamination occurrence of the transfer roller or a process for a long-time contamination occurrence of the transfer roller.

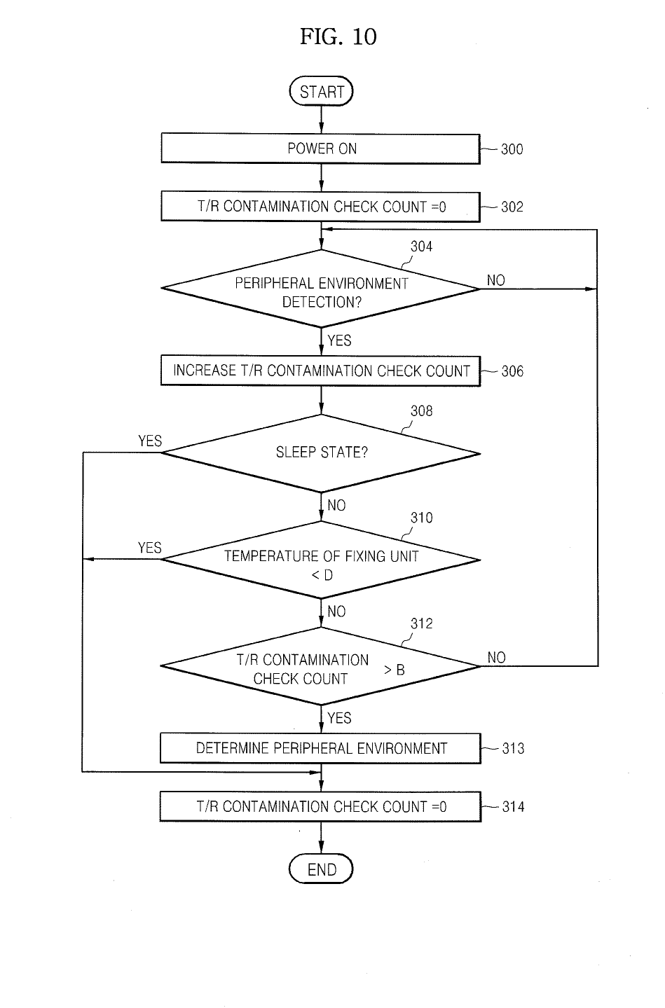

Referring to FIG. 10, if power is supplied to the image forming apparatus so that the image forming apparatus is turned on in operation S300, the system controller 100 sets the value of the transfer roller contamination check counter as zero in operation S302. If the condition for the detection of the peripheral environment is satisfied, it is determined whether peripheral environment has been detected in operation S304. The condition for the detection of the peripheral environment is previously set. For example, the condition that the peripheral environment is detected whenever a sheet of paper is printed may be set.

Whenever the peripheral environment is detected, the transfer roller contamination check counter accumulates and increases the frequency of the detection of the peripheral environment in operation S306. The accumulated frequency of the detection of the peripheral environment corresponds to the number of printed paper.

Then, the system controller 100 determines whether the image forming apparatus is in a sleep state representing that the image forming apparatus does not perform the printing operation in operation S308. If the image forming apparatus is not in the sleep state as the determination result, the system controller 100 determines whether the temperature of a fusing unit 65 measured through a temperature sensor 66 of the fusing unit 65 is lower than a reference fusing temperature D in operation S310. If the measured temperature of the fusing unit is not lower than the reference fusing temperature D, the system controller 100 determines whether the value of the transfer roller contamination check counter is greater than a reference value B that is used to determine the saturation state of the internal air temperature in operation S312.

If the image forming apparatus is in the sleep state in operation S308, if the temperature of the fusing unit is lower than the reference fusing temperature D in operation S310, or if the value of the transfer roller contamination check counter is greater than the reference value B in operation S312, a peripheral environment is determined in operation 313, and then the value of the transfer roller contamination check counter is set as zero in operation 314.

If the image forming apparatus is not in the sleep state in operation S308, if the temperature of the fusing unit is not smaller than the reference fusing temperature D in operation S310, or if the value of the transfer roller contamination check counter is greater than the reference value B in operation S312, operation S304 is performed in order to increase the value of the transfer roller contamination check counter.

As described above, the system controller 100 determines one of the process for the short-time contamination occurrence of the transfer roller to correspond to the short-time printing operation, or the process for the long-time contamination occurrence of the transfer roller to correspond to the long-time printing operation as a peripheral environment according to the transfer roller contamination check counter in operation 313.

It is possible that a detection result (resistance or temperature) of the T/R resistance measuring unit 80 of FIG. 3 can be used as the temperature of the fusing unit 65 in operation 310 of FIG. 10.

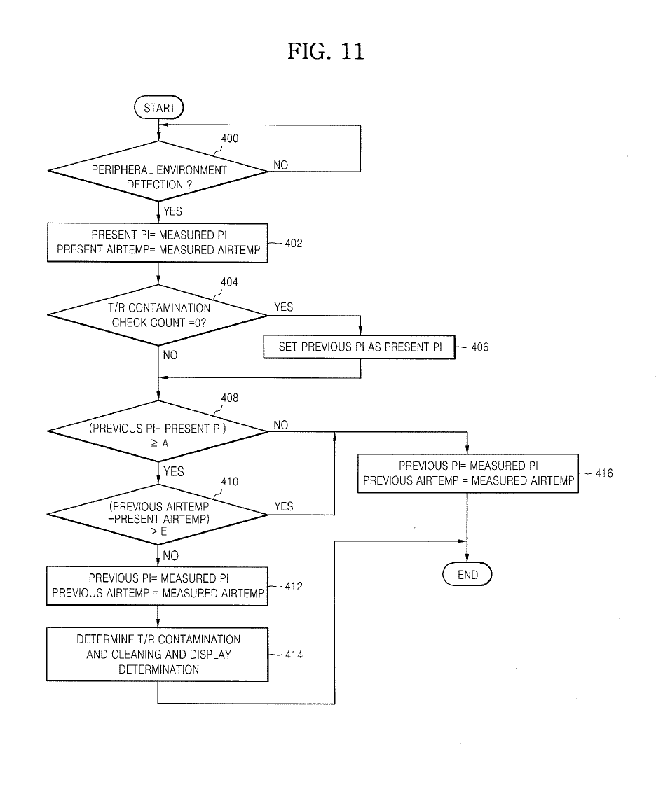

FIG. 11 is a flowchart illustrating a method of determining the contamination of a transfer roller during a short-time printing operation by employing an advanced peripheral environment detecting scheme according to an embodiment of the present general inventive concept.

As illustrated in FIG. 11, the system controller 100 determines through the transfer resistance measuring unit 80 and the internal temperature measuring unit 90 whether the peripheral environment is detected in operation S400. If the peripheral environment is performed, a measured PI value, which has been output from the first PI value calculation unit 130 according to the transfer resistance output from the transfer resistance measuring unit 80, is set as a present PI value, and a measured internal air temperature, which has been output from the second PI value calculation unit 140 according to the air temperature resistance from the internal temperature measuring unit 90, is set as a present air temperature value in operation S402.

Then, the system controller 100 determines whether the value of the transfer roller contamination check counter is zero in operation 404. If the value of the transfer roller contamination check counter is zero, a previous PI value stored in an internal storage unit 191 of the printing controller 190 is set as the present PI value in operation 406.

Thereafter, the system controller 100 determines whether a difference between the previous PI value and the present PI value is equal to or greater than a reference value A of FIG. 4 in operation S408.

If the difference between the previous PI value and the present PI value is equal to or greater than the reference value A, the system controller 100 determines whether a difference between the previous internal air temperature value and the present internal air temperature value is greater than a reference temperature E in operation S410.

If the difference between the previous internal air temperature value and the present internal air temperature value is not greater than the reference temperature E as the determination result of operation S410, the measured PI value is set as the previous PI value, and the measured internal air temperature value is set as the previous internal air temperature in operation 412.

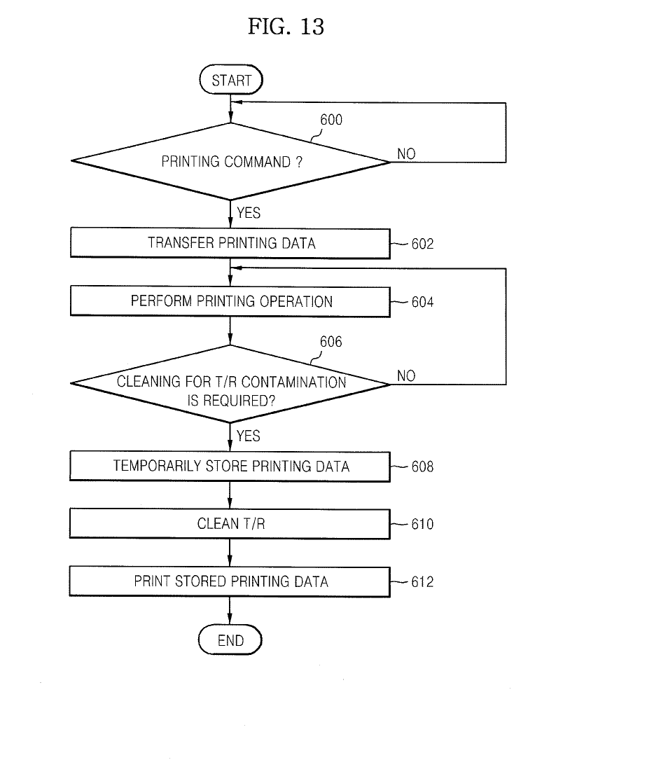

If the difference between the previous PI value and the present PI value is equal to or greater than the reference value A in operation S408, and if the difference between the previous internal air temperature value and the present internal air temperature value is not greater than the reference temperature E in operation S410 as described above, it is determined that the transfer roller is contaminated for a short time even if the internal air temperature is not saturated. In this case, it is determined that the transfer roller is contaminated, and the cleaning of the transfer roller is necessary, and the determination is displayed on the display unit 192 in operation 414. Then, the operational procedure is terminated. The cleaning operation of the transfer roller will be described later with reference to FIG. 13.

If the difference between the previous PI value and the present PI value is less than the reference value A in operation S408, and if the difference between the previous internal air temperature value and the present internal air temperature value is greater than the reference temperature E in operation S410, the measured PI value is set as the previous PI value, and the measured internal air temperature value is set as the previous internal air temperature value in operation S416. Thereafter, the operation procedure is terminated.

That is, the difference between the previous PI value and the present PI value is less than the reference value A in operation S408, and if the difference between the previous internal air temperature value and the present internal air temperature value is greater than the reference temperature E in operation S410, it can be determined that the transfer roller is not contaminated, when the operation 416 is performed.

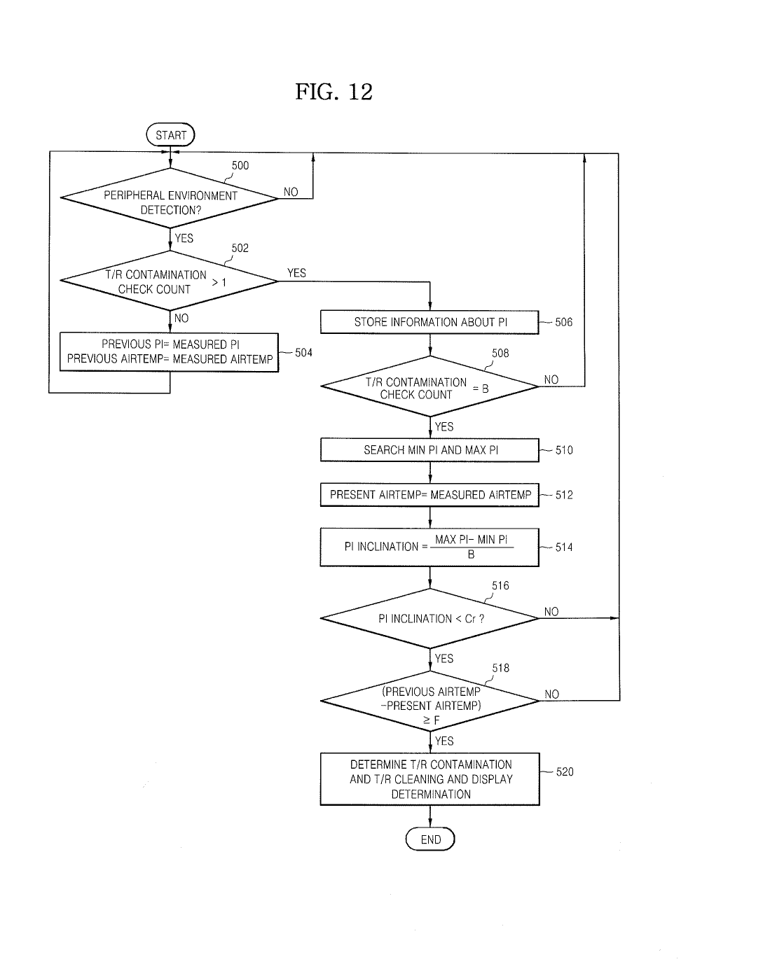

FIG. 12 is a flowchart illustrating a method of determining the contamination of a transfer roller during a long-time printing operation by employing an advanced peripheral environment detecting scheme according to an embodiment of the present general inventive concept. Hereinafter, the method will be described with reference to FIGS. 6 and 7.

The system controller 100 determines through the transfer resistance measuring unit 80 and the internal temperature measuring unit 90 whether peripheral environment is detected in operation S500. If the system controller 100 determines that the peripheral environment is detected, the system controller 100 determines whether the value of the transfer roller contamination check counter is greater than ‘1’ in operation S502. If the value of the transfer roller contamination check counter is not greater than ‘1’ as the determination result of step S502, the measured PI value is set as the previous PI value, and the measured internal air temperature value is set as the previous internal air temperature value in operation S504. Thereafter, the system controller performs operation S500.

If it is determined in operation S502 that the value of the transfer roller contamination check counter is greater than ‘1’, information about PI values, which are measured for a predetermined period of time from the initial stage (e.g., 250-paper printing operation for determining saturation state of the internal air temperature), is stored in the storage unit 191 in operation S506.

Then, it is determined whether the value of the transfer roller contamination check counter exceeds the reference value B (the reference number of paper for determining whether the internal air temperature is saturated) in operation S508. If the value of the transfer roller contamination check counter does not exceed the reference value B as the determination result, operation S500 is performed.

If the transfer roller contamination check value exceeds the reference value B, the maximum PI value and the minimum PI value are searched in the stored PI values in operation S510, and the measured internal air temperature value is set as the present internal air temperature value in operation S512, such that the PI value inclination is calculated through following equation.

PI inclination=(the maximum PI value−the minimum PI value)/B Equation

Thereafter, it is determined whether the calculated PI value inclination is smaller than a reference inclination Cr1 in operation S516. If it is determined that the calculated PI value inclination is smaller than the reference inclination Cr1, it is determined whether a difference between the previous internal air temperature and the present internal air temperature is equal to or greater than a reference temperature F in operation S518.

If a difference between the previous internal air temperature and the present internal air temperature is equal to or greater than the reference temperature F as a determination result in operation S518, it is determined that the measurement of transfer resistance does not match with the measurement of an internal air temperature so that the transfer roller may be increasingly contaminated, and the cleaning of the transfer roller is required, and the determination is displayed on the display unit 192 in operation S520. Then, the operational procedure is terminated. The cleaning procedure of the transfer roller is will be described later with reference to FIG. 13.

If it is determined that the calculated PI value inclination is not smaller than the reference inclination Cr1 in operation S516, or if it is determined that the difference between the previous internal air temperature and the present internal air temperature is not greater than the reference temperature F in operation S518, it is determined that the image forming apparatus is normally operated, so that operation 500 is performed.

FIG. 13 is a flowchart showing the operational procedure for performing a printing operation after the cleaning of the transfer roller when it is determined that the transfer roller is contaminated, by employing the advanced peripheral environment detecting scheme according to the present invention.

The system controller 100 determines whether a printing command is input in operation S600. If the printing command is input as the determination result, printing data is received from the host computer 200 in operation S602, and the printing data are printed in operation S604.

During the printing operation, the system controller 100 determines the cleaning of the transfer roller based on the determination for the contamination of the transfer roller shown in FIGS. 10 to 12 in operation S606.

If it is determined that the cleaning of the transfer roller is required, the printing data are temporarily stored in the storage unit 191 in operation S608, blank paper is fed from a paper cassette such that the non-printed paper passes between the transfer roller and the photoconductive drum to clean the transfer roller in operation S610.

The above cleaning operation of the transfer roller may be automatically performed using a cleaning unit (not illustrated) by the system controller 100, or manually performed by a user's command input through a manipulation panel of the image forming apparatus. A conventional cleaning unit can be used as the cleaning unit controlled by the system controller 100 to clean the transfer roller.

After the cleaning operation is performed, a new sheet of paper is supplied and then the printing operation of the printing data temporarily stored in the storage unit 191 is performed in operation S612.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As described above, according to the present general inventive concept, when a transfer roller is contaminated by non-transferred toner in the process of extracting jammed paper from the gap between the transfer roller and the photoconductive drum, the contamination of a transfer roller is detected and thus the transfer roller is cleaned. In addition, according to the present invention, when fine dusts are increasingly collected on the transfer roller due to a long-time printing operation so that the transfer roller is contaminated, the contamination of the transfer roller is detected so that the transfer roller is cleaned. According to the present invention, the erroneous determination of a contamination state of the transfer roller caused by the erroneous detection of peripheral environment can be prevented. Therefore, the reliability of the product can be improved.

Although exemplary embodiments of the present general inventive concept has been described for illustrative purposes, those skilled in the art will appreciate that various modifications, additions and substitutions are possible, without departing from the scope and spirit of the general inventive concept as disclosed in the accompanying claims.

What is claimed is:

1. An image forming apparatus comprising:
a resistance measuring unit to measure a resistance of a transfer roller;
a temperature measuring unit to measure an internal temperature;
a first detecting unit to detect a first peripheral environment by using the resistance of the transfer roller;
a second detecting unit to detect a second peripheral environment by using the internal temperature; and
a controller to determine contamination of the transfer roller by using the detection results of the first and second detecting units.

2. The image forming apparatus of claim 1, wherein the controller determines the contamination of the transfer roller according to the detection result of the second detecting unit after the first detecting unit detects the first peripheral environment.

3. The image forming apparatus of claim 1, further comprising:
a counter unit to accumulate a frequency of detection of a peripheral environment.

4. The image forming apparatus of claim 3, wherein the accumulated frequency of the detection of the peripheral environment corresponds to the number of printed sheets.

5. The image forming apparatus of claim 4, wherein the accumulated frequency of the detection of the peripheral environment or the number of the printed sheets is reset if the image forming apparatus is in a sleep state.

6. The image forming apparatus of claim 1, wherein the controller comprises:
a short-time contamination determining unit to determine whether contamination time of the transfer roller is first time; and
a long-time contamination determining unit to determine whether the contamination time of the transfer roller is second time greater than the first time.

7. The image forming apparatus of claim 6, wherein the short-time contamination determining unit determines that the transfer roller is contaminated if a difference between a previous PI value and a present PI value is not in a normal range, and the long-time contamination determining unit determines that the transfer roller is contaminated if PI value inclination is not a normal range.

8. The image forming apparatus of claim 1, further comprising:
a display unit to display the contamination of the transfer roller if the transfer roller is contaminated as the detection results of the first and second detecting units.

9. The image forming apparatus of claim 1, wherein the transfer roller is cleaned if the transfer roller is contaminated as the detection results of the first and second detecting units.

10. The image forming apparatus of claim 9, wherein the transfer roller is automatically cleaned, or manually cleaned according to a user's command.

11. The image forming apparatus of claim 10, wherein the user's command is input through a manipulation panel of the image forming apparatus.

12. The image forming apparatus of claim 1, further comprising:
a storage unit to store printing data if the transfer roller is contaminated, wherein the controller prints an image corresponding to the printing data stored in the storage unit on a new fed sheet after cleaning the transfer roller.

13. A method of controlling an image forming apparatus, the method comprising:
measuring resistance of a transfer roller;
measuring an internal temperature; and
determining contamination of the transfer roller by using detection results of a peripheral environment according to the measured resistance and the measured internal temperature.

14. The method of claim 13, wherein the determining of the contamination of the transfer roller comprises determining the contamination of the transfer roller according to the detection result of the peripheral environment based on the internal temperature after the peripheral environment is detected by using the resistance.

15. The method of claim 13, wherein the determining of the contamination of the transfer roller comprises:
determining contamination time; and
applying a contamination determining criterion varied depending on the contamination time.

16. The method of claim 15, wherein the determining of the contamination time comprises:
accumulating a frequency of detection of a peripheral environment; and
determining the contamination time as a short time or a long time according to the frequency of the detection of the peripheral environment.

17. The method of claim 16, wherein the frequency of the detection of the peripheral environment corresponds to the number of printed sheets.

18. The method of claim 17, wherein the frequency of the detection of the peripheral environment or the number of the printed sheets is reset if the image forming apparatus is a sleep state.

19. The method of claim 16, wherein whether a difference between a previous PI value and a present PI value is a normal range is determined if the contamination time is short time, and whether PI value inclination is in a normal range is determined if the contamination time is long time.

20. The method of claim 13, further comprising:
displaying the contamination of the transfer roller if the transfer roller is contaminated.

21. The method of claim 13, further comprising:
cleaning the transfer roller if the transfer roller is contaminated.

22. The method of claim 21, wherein the transfer roller is automatically cleaned or manually cleaned according to a user's command.

23. The method of claim 13, further comprising:
storing printing data if the transfer roller is contaminated; and
printing an image corresponding to the printing data on a new fed sheet after cleaning the transfer roller.

24. A computer-readable medium to contain computer-readable codes as a program to execute a method of an image forming apparatus, the method comprising:
measuring resistance of a transfer roller;
measuring an internal temperature; and
determining contamination of the transfer roller by using detection results of a peripheral environment according to the measured resistance and the measured internal temperature.

25. An image forming apparatus comprising:
a first measuring unit to measure a resistance of a transfer roller;
a second measuring unit to measure an internal temperature; and
a controller to determine contamination of the transfer roller according to a peripheral environment including the measured resistance and the measured internal temperature.
